(19) United States
(12) Patent Application Publication
(10) Pub. No.: US 2018/0060735 A1
(43) Pub. Date: Mar. 1, 2018

(54) USE OF ASSET AND ENTERPRISE DATA TO PREDICT ASSET PERSONALITY ATTRIBUTES

(71) Applicant: International Business Machines Corporation, Armonk, NY (US)

(72) Inventors: Bharath R. Ganesh, Bangalore (IN); Tuhin Sharma, Bangalore (IN)

(21) Appl. No.: 15/254,220

(22) Filed: Sep. 1, 2016

(51) Int. Cl. G06N 5/02; G06N 7/00

(52) U.S. Cl. CPC G06N 5/02; G06N 7/005

(57) ABSTRACT

Embodiments of the present invention provide systems and methods for predicting personality attributes. The method includes accessing a set of data for an operator. The method further includes analyzing the set of data, matching the operator to a set of personality attributes, and storing the matched set of personality attributes for the operator.

### BACKGROUND OF THE INVENTION

The present invention relates generally to the field of resource management, and more particularly to the use of operator (herein referred to as asset or operator interchangeably) data to predict an operator's psychometric profile, such as the big five personality traits (i.e., those traits recognized by most psychologists as the five basic dimensions of personality) of openness, conscientiousness, extraversion, agreeableness, and neuroticism, and the use of the predicted profile in operator assignment and management.

One of the key roles of leaders, managers, supervisors, directors, etc. (herein collectively referred to as managers) is to ensure that the employees, contractors, operators, etc. (herein collectively referred to as assets or operators) that are placed on tasks and in groups match the needs of those tasks and groups as best as the manager can determine. A better match generally means better, more efficient productivity, and a positive outcome for the team and the company as a whole. Because of this, managers are very motivated to determine the correct operator be placed where the operator would do the most good, such as on a particular piece of machinery, equipment, apparatus, hardware, or inanimate asset (herein collectively referred to as inanimate asset). However, often it is difficult to determine which operator would be a good fit until the position has already been filled and the task is underway. Any ability to decrease this uncertainty, and to increase the chances that the chosen operator is a good fit and a good choice for the position, would be considered a positive for most of those in leadership roles.

### SUMMARY

According to one embodiment of the present invention, a method for predicting personality attributes, the method comprising: accessing, by one or more processors, a set of data for an operator; analyzing, by one or more processors, the set of data; matching, by one or more processors, the operator to a set of personality attributes, with the match based, at least in part, on the analyzed set of data; and storing, by one or more processors, the matched set of personality attributes for the operator.

According to another embodiment of the present invention, a computer program product for remote query optimization in multi data sources is provided, based on the method described above.

According to another embodiment of the present invention, a computer system for remote query optimization in multi data sources is provided, based on the method described above.

### BRIEF DESCRIPTION OF THE DRAWINGS

FIG. 1 is a functional block diagram illustrating a data processing environment, in accordance with an embodiment of the present invention;

FIG. 2A is a flowchart illustrating operational steps for predicting operator personality, in accordance with an embodiment of the present invention;

FIG. 2B is a flowchart illustrating operational steps for predicting preferred operator placement, in accordance with an embodiment of the present invention;

FIG. 3 is an example of a visualization of the flow of inanimate asset and operator data for operator predictions, in accordance with an embodiment of the present invention; and

FIG. 4 is a block diagram of internal and external components of the computing device of FIG. 1, in accordance with an embodiment of the present invention.

### DETAILED DESCRIPTION

One of the key jobs of a manager is to ensure the assets, operators, and inanimate assets in a company, business, organization, team, group, etc., herein collectively referred to as company, are placed on tasks and in groups where the needs of those tasks and groups are met in the most efficient, productive, and positive way possible. A manager that chooses the right person, herein referred to as the operator or asset, for the task, generally creates an environment in which assigned tasks are finished in more efficient and positive ways. Groups that fit together and work well together are more likely to create positive environments that are beneficial to the group, the manager, and the company as a whole.

Embodiments of the present invention recognize the need to help a manager make better operator placement decisions. In some instances, a manager uses previous work experience to assign an operator to a task or to utilize an inanimate asset. For example, an operator who has worked with turbines for several years and is very efficient may be placed in a task that requires working with a team on the company's new turbine. However, this operator may not be the most suitable or best-fit operator for that particular team or that particular inanimate asset (the new turbine), due to personality conflicts or other issues. Thus there is a need to identify operators that not only have the skills, but also are an optimum operator, not just an efficient one. Embodiments of the present invention provide solutions for identifying the best-fit operator through the use of operator data, inanimate asset data, and enterprise data. In this manner, as discussed in greater detail herein, embodiments of the present invention can provide best-fit operators through prediction and matching of operator data and enterprise data with a manager's requirements for operator placement.

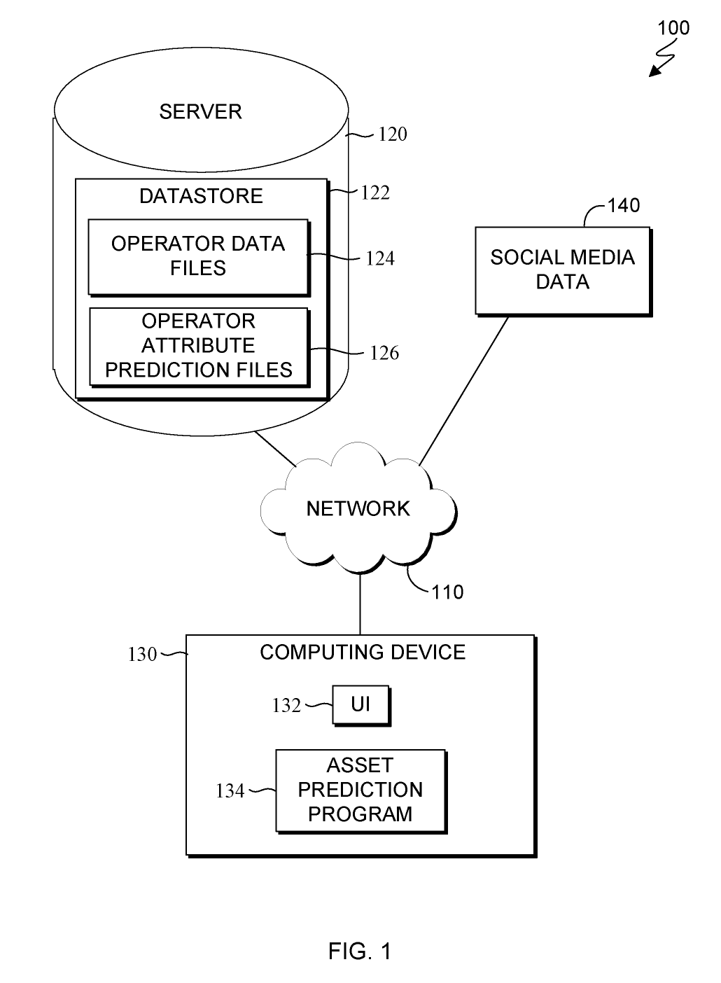

The present invention will now be described in detail with reference to the Figures. FIG. 1 is a functional block diagram illustrating a data processing environment, generally designated 100, in accordance with an embodiment of the present invention. Modifications to data processing environment 100 may be made by those skilled in the art without departing from the scope of the invention as recited by the claims. In an exemplary embodiment, data processing environment 100 includes server 120, computing device 130, and social media data 140, all interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication and/or access between server 120, computing device 130, and social media data 140.

Server 120 includes datastore 122, operator data files 124, and operator attribute prediction files 126. In various embodiments of the present invention, server 120 can be a server computer system such as a management server, a web server, or any other electronic device or computing system capable of sending and receiving data, or any computing system utilizing one or more computers and components to act as a single pool of seamless resources.

Datastore 122 includes operator data files 124 and operator attribute prediction files 126. In various embodiments of the present invention, datastore 122 can be a repository or a logical container, for persistently storing collections of data, such as a database, a file system, or a directory.

Operator data files 124 may include, but are not limited to: historic data for operators, such as work habits, efficiency, output, length of employment, projects operators participated in, length of each project, outcomes of projects, and personal or social data, such as an operator's social media accounts that a manager has access to; enterprise data; and wants, needs, and available projects of the managers. In this embodiment, operator data files 124 are stored locally, such as on computing device 130. In another embodiment, operator data files 124 may be stored in a combination of local and remote storage methods.

Operator attribute prediction files 126 may include predictions made by asset prediction program 134, such as personality predictions and best-fit scenarios, for multiple operators. In various embodiments, operator attribute prediction files 126 are stored locally, such as on computing device 130, or stored in a combination of local and remote storage methods.

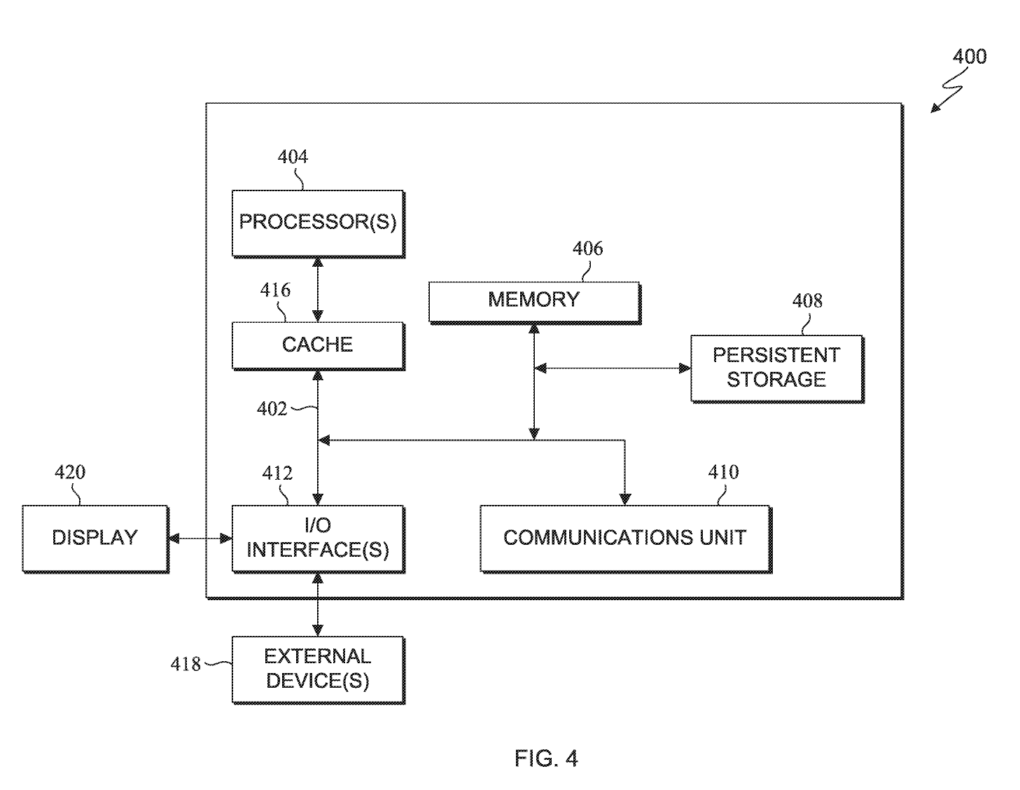

Computing device 130 includes user interface (UI) 132 and asset prediction program 134. In various embodiments of the present invention, computing device 130 can be a laptop computer, a tablet computer, a netbook computer, a personal computer (PC), a desktop computer, a personal digital assistant (PDA), a smart phone, a thin client, or any programmable electronic device capable of executing computer readable program instructions. Computing device 130 may include internal and external hardware components, as depicted and described in further detail with respect to FIG. 4.

UI 132 is a user interface that can display text, documents, web browser windows, user options, application interfaces, and instructions for operation. In this embodiment, UI 132 may be, for example, a graphical user interface (GUI) or a web user interface (WUI). UI 132 may also include the information a program presents to a user (such as graphics, text, and sound) and the control sequences the user employs to control the program. UI 132 is capable of receiving data, user commands, and data input modifications from a user. UI 132 is also capable of communicating with asset prediction program 134.

Asset prediction program 134 is an asset and operations analytic system capable of accessing information from various systems and programs, for example from operator data files 124, operator attribute prediction files 126, and social media data 140. Although depicted as a separate component, in one embodiment, asset prediction program 134 may be partially or fully integrated with UI 132. In this exemplary embodiment, asset prediction program 134 is capable of retrieving information via network 110. Asset prediction program 134 is capable of multiple functions, including: accessing data from such sources as operator data files 124, operator attribute prediction files 126, social media data 140, and data entered by one or more users through UI 132; predicting operator personalities, for example the Big 5 personality traits that many contemporary psychologists believe to be the basic dimensions of a person's personality (e.g., extraversion, agreeableness, openness, conscientiousness, and neuroticism); and determining the most optimized operator when predictively matching operators to tasks.

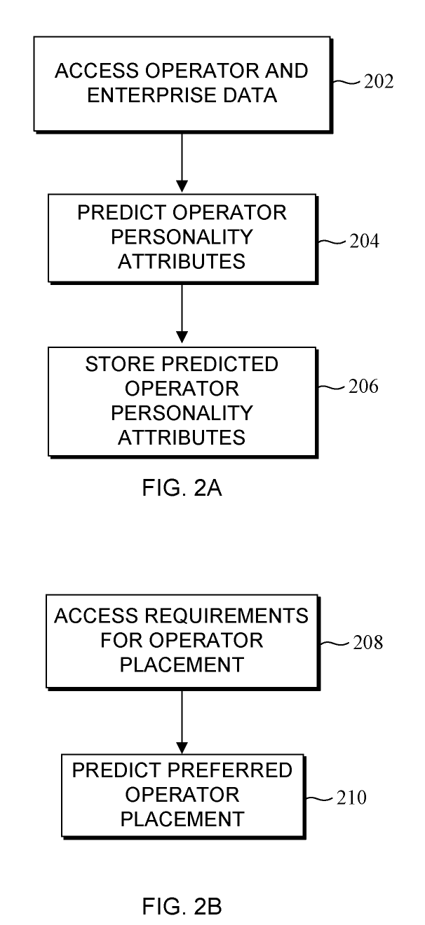

FIG. 2A is a flowchart illustrating operational steps for predicting operator personality, in accordance with an embodiment of the present invention.

In step 202, asset prediction program 134 accesses operator and enterprise data from a plurality of sources. In various embodiments, asset prediction program 134 accesses operator and enterprise data from sources including: data manually input from one or more users; data accessed from operator data files 124; data accessed from operator attribute prediction files 126; data accessed from social media data 140; or any combinations thereof. Operator data may include, but is not limited to: personality attributes obtained from social media interactions and social media profiles; personality traits obtained from personality questionnaires; an operator's effectiveness (i.e., how often an operator produced the desired result); an operator's social interactions, such as through social media or face to face interactions with co-workers; an operator's physical characteristics, such as the ability to lift certain amounts of weight; and other records about the operator that the company may have at its disposal. Additionally, operator data may include data for a new operator, or additional or updated data for an existing operator. In an exemplary embodiment, enterprise data may include, but is not limited to: an operator's longevity (i.e., the length of time the operator has been with the company and how long the operator has performed the task in question); attributes obtained from previous teams and projects within the company that the operator has worked for or interacted with; other operator demographics that the company has on file, such as age, gender, experience in years, team experience, and operator ratings and assessments; the company's demographics; and the company's business model and needs. In various embodiments, operators take personality tests, designed by the company, or by outside sources, for instance the Sixteen Personality Factor Questionnaire (16PF), and the tests and test results are included in the gathered data used by asset prediction program 134.

In step 204, asset prediction program 134 predicts an operator's personality attributes. In an exemplary embodiment, asset prediction program 134 analyzes the gathered data, through such methods as a supervised machine learning algorithm, and creates a prediction as to the operator's personality. Supervised machine learning algorithms may include, but are not limited to: Linear Regression, Neural Networks, and Support Vector Machines. The operator's personality attributes may include, but are not limited to: a Psychometric profile, such as the Big Five personality traits of openness, conscientiousness, extraversion, agreeableness, and neuroticism; an operator's attitude when faced with certain situations; and operative suitability in a variety of situations.

In one example, asset prediction program 134 analyzes, among other data, several years worth of social media posts by an operator. Asset prediction program 134 determines that, because the operator often posts pictures and comments about going out and spending time with friends, family, or in other social situations, that the operator has a high degree of extraversion. Additionally, because the posts are always considerate of friends, and many of the social situations are due to birthdays of friends, and cheering friends or family members up after they have experienced a difficult day or period in their life, while trying to downplay the operator's own part in making the friend or family member feel better, asset prediction program 134 also determines that the operator has a high degree of agreeableness especially in the agreeableness sub-traits of altruism and tender-mindedness.

In another example, asset prediction program 134 analyzes an operator's social media data, a personality questionnaire from the operator, and reviews from several of the operator's previous coworkers. Asset prediction program 134 determines that, because of a narcissistic tone in the social media posts and the personality questionnaire, and the more negative or formulaic comments on the coworkers reviews, the operator has a low degree of agreeableness and a high degree of neuroticism.

In step 206, asset prediction program 134 stores the predicted operator personality attributes. In an exemplary embodiment, asset prediction program 134 stores the operator personality attribute predictions in operator attribute prediction files 126, as they are generated.

FIG. 2B is a flowchart illustrating operational steps for predicting preferred operator placement, in accordance with an embodiment of the present invention.

In step 208, asset prediction program 134 accesses requirements for operator placement. In an exemplary embodiment, asset prediction program 134 accesses data input for the requirements from one or more users, and may be input through UI 132, accessed from server 120, or both. The data for operator placement may include, but is not limited to: desired efficiency for an operator; desired longevity for an operator; desired, suitable personality for an operator; desired skillset for an operator; additional operator data; necessary skills for a task; inanimate asset data, such as necessary training required to operate the inanimate asset, and experience required for efficient operation of the inanimate asset; and enterprise, group, or task data.

In step 210, asset prediction program 134 predicts the preferred operator placement. In an exemplary embodiment, asset prediction program 134 compares and analyzes the data received for the requirements for operator placement, and the predictions of operator personality attributes retrieved from storage (i.e., FIG. 2A, step 204 and 206). Asset prediction program 134 compares and analyzes the data using supervised machine learning algorithms in order to create predictions for the placement of a preferred, suitable, or best-fit, operator for the position, or the use of the inanimate asset. Asset prediction program 134 uses the analysis and comparison to predict whether the operator would not only meet the requirements for operator placement, but would be well suited for placement in the team or on the desired tasks. For example, if a manager requires someone to operate a specific inanimate asset, such as a turbine, and there are certain criteria for operating the inanimate asset optimally, other than knowing how it theoretically works, for instance a certain level of focus, intuition, or ability to work in a team, asset prediction program 134 predicts an operator that is suitable for operating the specific inanimate asset.

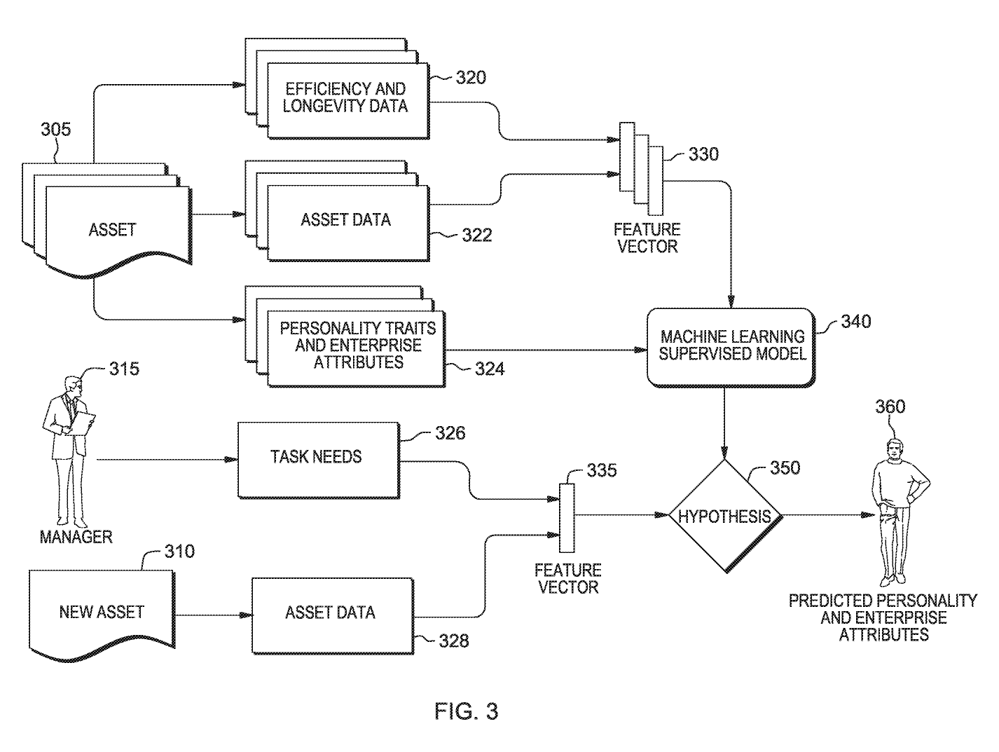

FIG. 3 depicts an example of a visualization of the flow of inanimate asset and operator data for operator predictions, in accordance with an embodiment of the present invention. In this exemplary embodiment, asset 305 and new asset 310 are inanimate assets whose data will be analyzed by asset prediction program 134. Asset 305 is an inanimate asset previously and/or currently used by the company. Asset 305 has multiple pieces of information that is able to be input into asset prediction program 134, such as efficiency and longevity data 320, asset data 322, and personality traits and enterprise attributes 324. Efficiency and longevity data 320 may include any efficiency or production metrics and ratings that the company may keep records of for inanimate assets, including various operator efficiency metrics previously determined. Asset data 322 may include an inanimate asset's uses, requirements, efficiency metrics, necessary training, or other data about the inanimate asset. Personality traits and enterprise attributes 324 may include data for operators currently or previously assigned to the inanimate asset, personality tests given by the company or by outside agencies, peer reviews, efficiency when using the inanimate asset, needs the company may have, and needs the manager or managers may have, such as expected efficiency. New asset 310 is a new inanimate asset not previously used by the company or the manager, wherein the only data available (i.e., asset data 328) is the basic data similar to asset data 322 for asset 305. Manager 315 is the manager using asset prediction program 134. Manager 315 inputs task needs 326 to tell asset prediction program 134 what the requirements for operator placement are (i.e., step 208 of FIG. 2B).

In this exemplary embodiment, feature vector 330 and 335 are n-dimensional vectors for machine learning supervised model 340. Feature vector 330 and 335 receive their individual data points (i.e., feature vector 330 receives data from efficiency and longevity data 320 and asset data 322, while feature vector 335 receives data from task needs 326 and asset data 328), and convert the data into necessary representations in order to facilitate process and analysis by asset prediction program 134 and machine learning supervised model 340. Machine learning supervised model 340 analyzes the data supplied, through Linear Regression Models, Neural Networks, Support Vector Machines, or other models or combinations thereof, in order to predict the Psychometric profile of the operator. Using the predictions determined by machine learning supervised model 340, and the data from feature vector 335, asset prediction program 134 determines hypothesis 350. Hypothesis 350 is a scaled, predicted ranking of suitable operators for the tasks or use of inanimate assets that are input in task needs 326. As it may not be possible to find an operator who has an exact match as those of the predicted attributes necessary for task needs 326, there may be a similarity threshold or ranking, between the predicted attributes and those of the attributes of existing operators. Depending on the threshold, one or more operators may be selected as a suitable operator for the tasks or groups input in task needs 326. Once the one or more operators are determined, asset prediction program 134 returns predicted personality and enterprise attributes 360. Predicted personality and enterprise attributes 360 are the predicted best-fit operator or operators for the needs of manager 315, the task, and the company. In various embodiments, the following may occur: there may not be a new asset 310; all data may pass through a single feature vector; all data may pass through multiple feature vectors; there may be more than one manager 315 utilizing the system; or any combination thereof.

FIG. 4 is a block diagram of internal and external components of a computer system 400, which is representative of the computer systems of FIG. 1, in accordance with an embodiment of the present invention. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to: personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 400 includes communications fabric 402, which provides for communications between one or more processors 404, memory 406, persistent storage 408, communications unit 410, and one or more input/output (I/O) interfaces 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In general, memory 406 can include any suitable volatile or non-volatile computer-readable storage media. Software (e.g., asset prediction program 134, etc.) is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer-readable storage medium that is also part of persistent storage 408.

Communications unit 410 provides for communications with other computer systems or devices via a network (e.g., network 110). In this exemplary embodiment, communications unit 410 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computing device 130 through communications unit 410 (e.g., via the Internet, a local area network or other wide area network). From communications unit 410, the software and data can be loaded onto persistent storage 408.

One or more I/O interfaces 412 allow for input and output of data with other devices that may be connected to computer system 400. For example, I/O interface 412 can provide a connection to one or more external devices 418 such as a keyboard, computer mouse, touch screen, virtual keyboard, touch pad, pointing device, or other human interface devices. External devices 418 can also include portable computer-readable storage media such as, for example, thumb drives, portable optical or magnetic disks, and memory cards. I/O interface 412 also connects to display 420.

Display 420 provides a mechanism to display data to a user and can be, for example, a computer monitor. Display 420 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to: an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for predicting personality attributes, the method comprising:
accessing, by one or more processors, a set of data for an operator;
analyzing, by one or more processors, the set of data;
matching, by one or more processors, the operator to a set of personality attributes, with the match based, at least in part, on the analyzed set of data; and
storing, by one or more processors, the matched set of personality attributes for the operator.

2. The method of claim 1, further comprising:
accessing, by one or more processors, a set of enterprise data for the operator;
analyzing, by one or more processors, the set of data for the operator and the set of enterprise data for the operator;
matching, by one or more processors, the operator to a set of personality attributes, with the match based, at least in part, on the analyzed set of data; and
storing, by one or more processors, the matched set of personality attributes for the operator.

3. The method of claim 1, further comprising:
receiving, by one or more processors, one or more personality tests for the operator;
analyzing, by one or more processors, the one or more personality tests;
matching, by one or more processors, the operator to a set of personality attributes, with the match based, at least in part, on the analyzed personality tests; and
storing, by one or more processors, the matched set of personality attributes for the operator.

4. The method of claim 1, further comprising:
receiving, by one or more processors, a set of requirements, wherein the set of requirements is for a task; and
storing, by one or more processors, the set of requirements.

5. The method of claim 4, further comprising:
accessing, by one or more processors, the stored set of requirements and the stored matched set of personality attributes for the operator;
comparing, by one or more processors, the set of requirements and the matched set of personality attributes; and
creating, by one or more processors, a ranked list of operators whose personality attributes match the set of requirements for the task, based, at least in part, on the comparison.

6. The method of claim 1, wherein the operator data comprises: personality attributes obtained from social media interactions and social media profiles; personality traits obtained from personality questionnaires; Psychometric profiles; effectiveness of the operator; social interactions through social media or face to face interactions with co-workers; physical characteristics, including ability to lift certain amounts of weight; and other records about the operator that a company may have at its disposal.

7. The method of claim 2, wherein the enterprise data comprises: the length of time the operator has been with a company; the length of time the operator has performed a specific task; attributes obtained from previous teams and projects, within the company, that the operator has worked for or interacted with; other operator demographics that the company has on file, including age, gender, experience in years, team experience, and operator ratings and assessments; specifications and training required for an inanimate asset; the demographics of the company; the business model of the company; and the needs of the company.

8. A computer program product for predicting personality attributes, the computer program product comprising:
one or more computer readable storage medium and program instructions stored on the computer readable storage medium, the program instructions comprising:
program instructions to access a set of data for an operator;
program instructions to analyze the set of data;
program instructions to match the operator to a set of personality attributes, with the match based, at least in part, on the analyzed set of data; and
program instructions to store the matched set of personality attributes for the operator.

9. The computer program product of claim 8, wherein the program instructions stored on the computer readable storage medium further comprise:
program instructions to access a set of enterprise data for the operator;
program instructions to analyze the set of data for the operator and the set of enterprise data for the operator;
program instructions to match the operator to a set of personality attributes, with the match based, at least in part, on the analyzed set of data; and
program instructions to store the matched set of personality attributes for the operator.

10. The computer program product of claim 8, wherein the program instructions stored on the computer readable storage medium further comprise:
program instructions to receive one or more personality tests for the operator;
program instructions to analyze the one or more personality tests;
program instructions to match the operator to a set of personality attributes, with the match based, at least in part, on the analyzed personality tests; and
program instructions to store the matched set of personality attributes for the operator.

11. The computer program product of claim 8, wherein the program instructions stored on the computer readable storage medium further comprise:
program instructions to receive a set of requirements, wherein the set of requirements is for a task; and
program instructions to store the set of requirements.

12. The computer program product of claim 11, wherein the program instructions stored on the computer readable storage medium further comprise:
program instructions to access the stored set of requirements and the stored matched set of personality attributes for the operator;
program instructions to compare the set of requirements and the matched set of personality attributes; and
program instructions to create a ranked list of operators whose personality attributes match the set of requirements for the task, based, at least in part, on the comparison.

13. The computer program product of claim 8, wherein the operator data comprises: personality attributes obtained from social media interactions and social media profiles; personality traits obtained from personality questionnaires; Psychometric profiles; effectiveness of the operator; social interactions through social media or face to face interactions with co-workers; physical characteristics, including ability to lift certain amounts of weight; and other records about the operator that a company may have at its disposal.

14. The computer program product of claim 9, wherein the enterprise data comprises: the length of time the operator has been with a company; the length of time the operator has performed a specific task; attributes obtained from previous teams and projects, within the company, that the operator has worked for or interacted with; other operator demographics that the company has on file, including age, gender, experience in years, team experience, and operator ratings and assessments; specifications and training required for an inanimate asset; the demographics of the company; the business model of the company; and the needs of the company.

15. A computer system for predicting personality attributes, the computer system comprising:
one or more computer processors;
one or more computer readable storage media;
program instructions stored on the one or more computer readable storage media for execution by at least one of the one or more processors, the program instructions comprising:
program instructions to access a set of data for an operator;
program instructions to analyze the set of data;
program instructions to match the operator to a set of personality attributes, with the match based, at least in part, on the analyzed set of data; and
program instructions to store the matched set of personality attributes for the operator.

16. The computer system of claim 15, further comprising:
program instructions to access a set of enterprise data for the operator;
program instructions to analyze the set of data for the operator and the set of enterprise data for the operator;
program instructions to match the operator to a set of personality attributes, with the match based, at least in part, on the analyzed set of data; and
program instructions to store the matched set of personality attributes for the operator.

17. The computer system of claim 15, further comprising:
program instructions to receive one or more personality tests for the operator;
program instructions to analyze the one or more personality tests;
program instructions to match the operator to a set of personality attributes, with the match based, at least in part, on the analyzed personality tests; and
program instructions to store the matched set of personality attributes for the operator.

18. The computer system of claim 15, further comprising:
program instructions to receive a set of requirements, wherein the set of requirements is for a task; and
program instructions to store the set of requirements.

19. The computer system of claim 18, further comprising:
program instructions to access the stored set of requirements and the stored matched set of personality attributes for the operator;
program instructions to compare the set of requirements and the matched set of personality attributes; and
program instructions to create a ranked list of operators whose personality attributes match the set of requirements for the task, based, at least in part, on the comparison.

20. The computer system of claim 15, wherein the operator data comprises: personality attributes obtained from social media interactions and social media profiles; personality traits obtained from personality questionnaires; Psychometric profiles; effectiveness of the operator; social interactions through social media or face to face interactions with co-workers; physical characteristics, including ability to lift certain amounts of weight; and other records about the operator that a company may have at its disposal.
